(19) United States
(12) Patent Application Publication
(10) Pub. No.: US 2019/0035420 A1
(43) Pub. Date: Jan. 31, 2019

(54) INFORMATION PROCESSING DEVICE, INFORMATION PROCESSING METHOD, AND PROGRAM

(71) Applicant: SONY CORPORATION, TOKYO (JP)

(72) Inventor: REIKO KIRIHARA, TOKYO (JP)

(21) Appl. No.: 16/069,072

(22) PCT Filed: Jan. 20, 2017
(86) PCT No.: PCT/JP2017/001866

§ 371 Date: Jul. 10, 2018

(30) Foreign Application Priority Data
Mar. 29, 2016 (JP) 2016-065744

(51) Int. Cl. G10L 25/63; G06F 17/30; G10L 15/22; G10L 15/18; G06F 17/27

(52) U.S. Cl. CPC G10L 25/63; G06F 17/30743; G06F 17/2755; G10L 15/18; G10L 15/22

(57) ABSTRACT

[Object] To provide an information processing device, an information processing method, and a program. [Solution] The information processing device includes: a scoring unit configured to perform scoring on a basis of ambiguous voice evaluation made by a user with regard to a piece of content included in a content list including a plurality of pieces of the content; and a content selection unit configured to select a piece of the content from the content list, on a basis of a result of the scoring.

### TECHNICAL FIELD

The present disclosure relates to an information processing device, an information processing method, and a program.

### BACKGROUND ART

In recent years, voice output based on a speech recognition technology is used as one of input methods from users to information processing devices. For example, Patent Literature 1 describes a technology of outputting feedback information to a user with regard to an information processing device capable of receiving voice input based on a speech recognition technology. The feedback information indicates a result of speech recognition performed by the information processing device.

In addition, studies on personalization technologies have been performed. The personalization technology performs a process more suitable for each user with regard to a device, a service, or the like which is used by a plurality of users. For example, there is a technology of providing content more suitable for a user on the basis of histories of operations, selections, viewing, and the like performed by the user.

### CITATION LIST

### Patent Literature

Patent Literature 1: JP 2011-209786A

### DISCLOSURE OF INVENTION

### Technical Problem

However, in the above-described personalization technology, it may become impossible to provide content suitable for the user in the case where there are less histories of operations, selections, viewing, and the like. It is burdensome for the user to perform operation, selection, viewing, and the like a number of times.

Accordingly, the present disclosure proposes a novel and improved information processing device, information processing method, and program that are capable of reducing burden on a user and providing content suitable for the user.

### Solution to Problem

According to the present disclosure, there is provided an information processing device including: a scoring unit configured to perform scoring on a basis of ambiguous voice evaluation made by a user with regard to a piece of content included in a content list including a plurality of pieces of the content; and a content selection unit configured to select a piece of the content from the content list, on a basis of a result of the scoring.

In addition, according to the present disclosure, there is provided an information processing method including: performing scoring by a processor on a basis of ambiguous voice evaluation made by a user with regard to a piece of content included in a content list including a plurality of pieces of the content; and selecting a piece of the content from the content list, on a basis of a result of the scoring.

In addition, according to the present disclosure, there is provided a program that causes a computer to achieve: a function of performing scoring on a basis of ambiguous voice evaluation made by a user with regard to a piece of content included in a content list including a plurality of pieces of the content; and a function of selecting a piece of the content from the content list, on a basis of a result of the scoring.

### Advantageous Effects of Invention

As described above, according to the present disclosure, it is possible to reduce burden on a user and provide content suitable for the user.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an overview of an information processing device according to an embodiment of the present disclosure.

FIG. 2 is a block diagram illustrating an example of a configuration of an information processing device 1 according to the embodiment.

FIG. 3 is a flowchart illustrating an example of a process workflow of the information processing device 1 according to the embodiment.

FIG. 4 is a flowchart illustrating an example of a process workflow of scoring performed by a scoring unit 104 according to the embodiment.

FIG. 5 is an explanatory diagram illustrating a specific example of a conversational operation with a user according to the embodiment.

FIG. 6 is a flowchart illustrating an example of a process workflow of the information processing device 1 according to a modification in which the scoring unit 104 performs scoring again on a same piece of content.

FIG. 7 is a flowchart illustrating an example of a workflow of a scoring process according to the modification.

FIG. 8 is an explanatory diagram illustrating a specific example of a conversational operation with a user according to the modification.

FIG. 9 is a flowchart illustrating an example of a process workflow of the information processing device 1 according to a modification in which an output control unit 106 prompts a user to make voice evaluation.

FIG. 10 is an explanatory diagram illustrating a hardware configuration example.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, the description is given in the following order.
<<1. Overview>>
<<2. Configuration example>>
<<3. Operation>>
<3-1. Process workflow>
<3-2. Specific example>
<<4. Modifications>>
<4-1. First modification>
<4-2. Second modification>
<4-3. Third modification>
<4-4. Fourth modification>
<4-5. Fifth modification>
<4-6. Sixth modification>
<4-7. Seventh modification>
<4-8. Eighth modification>
<<5. Hardware configuration example>>
<<6. Conclusion>>

### <<1. Overview>>

There are known personalization technologies of performing a process more suitable (personalized) for each user with regard to a device, a service, or the like which is used by a plurality of users. For example, it is possible to provide or recommend content (music, video, information, application, or the like) more suitable for a user on the basis of histories of operations, selections, viewing, and the like performed by the user.

However, it may become impossible to provide content suitable for the user in the case where there are less histories of operations, selections, viewing, and the like. It is burdensome for the user to perform operation, selection, viewing, and the like a number of times.

In addition, it is considered that whether a user is satisfied with content provided through the personalization technology is determined from an action (such as reproduction, stopping, skipping, and the like of the content) performed by the user with regard to the content. However, it is impossible to make high-precision evaluation.

In addition, sometimes preference of the user may change in accordance with an endogenous/exogenous state of the user, passage of time, or the like. Therefore, there is a possibility that a personalization result does not match the preference of the user and the user feels that the personalization technology does not work.

Therefore, the present embodiment has been developed in view of the above described circumstance. According to the present embodiment, scoring (assignment of scores) is performed on the basis of voice evaluation made by a user on pieces of content, and a piece of the content is selected. This enables reduction in burden on the user and provision of the piece of content suitable for the user. Next, an overview of the information processing device according to the embodiment with such effects will be described.

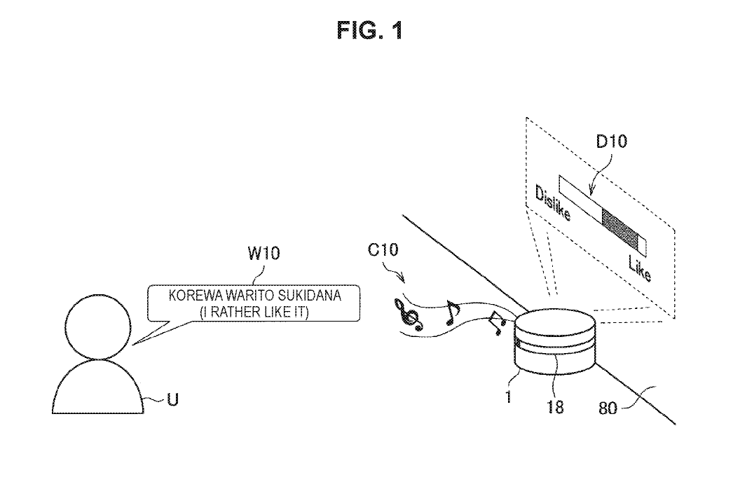

FIG. 1 is an explanatory diagram illustrating an overview of an information processing device according to an embodiment of the present disclosure. An information processing device 1 illustrated in FIG. 1 detects a user U around the information processing device 1, and provides content to the detected user U. The content provided to the user by the information processing device 1 is not specifically limited. For example, the content may be music such as a piece C10 of content illustrated in FIG. 1.

For example, the information processing device 1 generates a content list including a plurality of pieces of content corresponding to the user U (candidates for a piece of content suitable for the user U), and sequentially reproduces pieces of content included in the content list (provides partial pieces of content) for trial listening. In the example illustrated in FIG. 1, the information processing device 1 reproduces the piece C10 of the content for trial listening, and the user U speaks voice evaluation W10 connected to scoring with regard to the piece C10 of the content.

In addition, the information processing device 1 performs scoring of the piece C10 of the content on the basis of the voice evaluation W10 that has been spoken by the user U and that is connected to the scoring, and the information processing device 1 selects a piece of the content from the content list on the basis of a result of the scoring (such as scores). For example, the selected piece of content may be provided from the beginning to the end (full reproduction).

For example, such a configuration enables selection of a piece of content on the basis of ambiguous voice evaluation like the voice evaluation W10 illustrated in FIG. 1. Therefore, it is possible to reduce burden on a user and provide pieces of content suitable for the user.

In addition, the appearance of the information processing device 1 is not specifically limited. For example, as illustrated in FIG. 1, the appearance of the information processing device 1 may be a circular cylindrical shape, and the information processing device lmay be placed on a floor or a table in a room. In addition, the information processing device 1 includes a band-like light emitting unit 18 constituted by light emitting elements such as light-emitting diodes (LEDs) such that the band-like light emitting unit 18 surrounds a central region of a side surface of the information processing device 1 in a horizontal direction. By lighting a part or all of the light emitting unit 18, the information processing device 1 can notify a user of states of the information processing device 1. For example, by lighting a part of the light emitting unit 18 in a user direction (that is, talker direction) during conversation with the user, the information processing device 1 can operate as if the information processing device 1 looks on the user U who is a conversation partner, as illustrated in FIG. 1. In addition, by controlling the light emitting unit 18 such that the light rotates around the side surface during generating a response or searching for data, the information processing device 1 can notify the user that a process is ongoing. In addition, for example, the information processing device 1 has a function of projecting and displaying an image on a wall 80 as illustrated in FIG. 1. The information processing device 1 can output display in addition to outputting sound.

For example, the information processing device 1 outputs a result of the scoring (scoring result). In the example illustrated in FIG. 1, the information processing device 1 projects (outputs) a scoring result D10 related to the piece C10 of the content on the wall 80.

Such a configuration causes the user U to understand that the scoring is performed on the basis of the ambiguous voice evaluation, and causes the user U to feel that the personalization technology works. In addition, since the user U understands that the scoring is performed on the basis of the ambiguous voice evaluation, the user U is encouraged to voluntarily make voice evaluation to improve the performance of the personalization.

The overview of the information processing device 1 according to the present disclosure has been described above. Noe that, the shape of the information processing device 1 is not limited to the circular cylindrical shape illustrated in FIG. 1. For example, the shape of the information processing device 1 may be a cube, a sphere, a polyhedron, or the like. Next, details of a configuration example of the information processing apparatus 1 according to an embodiment of the present disclosure will be described.

### <<2. Configuration Example>>

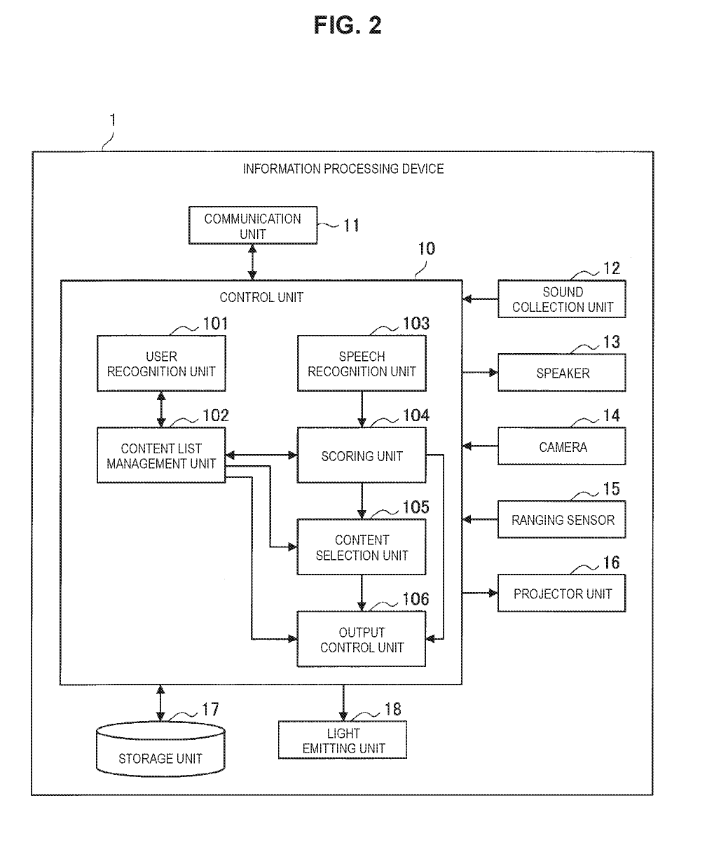

FIG. 2 is a block diagram illustrating an example of a configuration of the information processing device 1 according to the present embodiment. As illustrated in FIG. 2, the information processing device 1 includes a control unit 10, a communication unit 11, a sound collection unit 12, a speaker 13, a camera 14, a ranging sensor 15, a projector unit 16, a storage unit 17, and a light emitting unit 18.

The control unit 10 controls respective structural elements of the information processing device 1. In addition, as illustrated in FIG. 2, the control unit 10 also functions as a user recognition unit 101, a content list management unit 102, a speech recognition unit 103, a scoring unit 104, a content selection unit 105, and an output control unit 106.

The user recognition unit 101 detects and identifies a user around the information processing device 1. For example, the user recognition unit 101 detects a user by using a known face detection technology, a person detection technology, or the like on the basis of images acquired by the camera 14 and distances acquired by the ranging sensor 15. In addition, the user recognition unit 101 identifies a user by using a known face recognition technology or the like on the basis of images acquired by the camera 14.

For example, the user recognition unit 101 may identify a user in accordance with matching between identification information of a known user stored in the storage unit 17 and information extracted from a user detected in the image. In addition, the user recognition unit 101 may provide the identification information of the identified user to the content list management unit 102.

The content list management unit 102 manages a content list including a plurality of pieces of content corresponding to a user identified by the user recognition unit 101 (candidates for a piece of content suitable for the user U). The content list management unit 102 may manage the content list on the basis of a result of scoring performed by the scoring unit 104 (to be described later). According to this configuration, the content list becomes a content list based on preference of the user.

For example, the content list management unit 102 generates or updates a content list on the basis of a result of scoring performed by the scoring unit 104 (to be described later). The content list may be generated such that the content list includes pieces of content to which high scores have been assigned (which have been highly scored) in the past on the basis of voice evaluation made by the user, or pieces of content which are similar to such pieces of content. This configuration enables the generated content list to include pieces of content more suitable for each user.

In addition, in the case where the scoring unit 104 has assigned a score higher than a predetermined threshold to a certain piece of content, the content list management unit 102 may update the content list such that the content list includes a piece of content similar to the certain piece of content. In addition, in the case where the scoring unit 104 has assigned a score lower than a predetermined threshold to a certain piece of content, the content list management unit 102 may update the content list such that the content list does not include a piece of content similar to the certain piece of content. This configuration enables the content list to include pieces of content suitable for each user in accordance with the scoring performed by the scoring unit 104.

The speech recognition unit 103 recognizes a voice of a user (such as voice evaluation made by the user with regard to a piece of content) collected by the sound collection unit 12 (to be described later), converts the voice to a character string, and acquires speech text. Note that, it is also possible for the speech recognition unit 103 to identify a person who is speaking on the basis of a feature of the voice, or to estimate a direction of a voice source (in other words, a talker). In addition, it is also possible for the speech recognition unit 103 to determine whether the user is speaking (for example, voice evaluation).

The scoring unit 104 performs scoring (assignment of a score) of a piece of content on the basis of the speech text acquired by the speech recognition unit 103 on the basis of the voice evaluation made by the user with regard to the piece of content. The scoring unit 104 may perform scoring by using various methods. Next, some examples of scoring performed by the scoring unit 104 will be described.

The scoring unit 104 may detect score wording representing a score in the speech text acquired by the speech recognition unit 103, and may perform scoring on the basis of the score wording. The table 1 listed below is a table showing examples of scoring based on score wording.

TABLE 1
Examples of scoring based on score wording

| Speech Example | Score Example | |
|---|---|---|
| P1: hachijutten (80 points) | 80 | points |
| P2: hyakuten manten (perfect hundred points) | 100 | points |
| P3: gojutten kana (probably 50 points) | 50 | points |

In this case, for example, the speech text based on the voice evaluation may be score wording itself representing a score of “80 points” like the speech example P1. On the other hand, the speech text may include words other than score wording such as “100 points” or “50 points” like the speech example P2 or P3.

This configuration enables scoring that reflects intentions of the user more accurately.

In addition, the scoring unit 104 may perform scoring (assignment of a score) of a piece of content on the basis of ambiguous voice evaluation made by a user with regard to the piece of content. For example, the ambiguous voice evaluation may be a speech that does not directly represent a score (a speech that does not include score wording as described above).

For example, the scoring unit 104 may detect predetermined wording associated with a score in speech text acquired by the speech recognition unit 103 on the basis of voice evaluation made by the user with regard to a piece of content, and may perform scoring on the basis of the predetermined wording. For example, the association between the score and the predetermined wording may be stored in the storage unit 17 (to be described later). The table 2 listed below is a table showing examples of scoring based on score wording.

TABLE 2
Examples of scoring based on predetermined wording

| Speech Example | Score Example | |
|---|---|---|
| F1: iine (good) | 80 | points |
| F2: naisu (nice) | 80 | points |
| F3: gureeto (great) | 90 | points |
| F4: paafekuto (perfect) | 100 | points |
| F5: suki (like) | 100 | points |
| F6: kirai (dislike) | 0 | point |
| F7: futsuu (okay) | 50 | points |

This configuration enables scoring by speaking predetermined wording such as the speech examples F1 to F7 illustrated in the table 2, even in the case where a user does not want to clearly express the score.

In addition, it is also possible for the scoring unit 104 to make voice evaluation on the basis of semantic analysis of a natural speech. The table 3 listed below is a table showing examples of scoring based on semantic analysis of natural speeches.

TABLE 3
Examples of scoring based on semantic
analysis of natural speeches

| Speech Example | Score Example | |
|---|---|---|
| N1: korewa ammari sukija nainaa (I don't really like it) | 20 | points |
| N2: korewa warito sukidana (I rather like it) | 80 | points |
| N3: korega iina! (I love it!) | 100 | points |
| N4: maa-maa kana (so-so) | 50 | points |
| N5: kirai (I dislike it) | 0 | point |

This configuration enables scoring by using speeches like the speech examples N1 to N5 in the table 3 which are more unfettered than the speech examples F1 to F7 in the table 2. Note that, the speech example N5 in the table 3 is the same as the speech example F6 in the table 2. The scoring may be performed on the basis of detection of predetermined wording in the speech example F6, or the scoring may be performed after performing semantic analysis on the speech example F6 as a natural speech.

In addition, in the case where the scoring unit 104 performs scoring through semantic analysis of a natural speech, the scoring unit 104 may perform morphological analysis on speech text acquired by the speech recognition unit 103 on the basis of voice evaluation made by a user with regard to a piece of content, for example. In addition, the scoring unit 104 may perform scoring on the basis of a result of the morphological analysis. The tables 4 to 8 listed below are tables showing morphological analysis results of the respective speech examples N1 to N5 shown in the above-listed table 3.

TABLE 4
Morphological analysis result of speech example N1

| Word | Part of Speech |
|---|---|
| kore (it) | Noun |
| wa | Particle |
| ammari (really) | Adverb |
| suki (like) | Adjectival noun |
| ja | Particle |
| nai (don't) | Adjective |
| naa | Particle |

TABLE 5
Morphological analysis result of speech example N2

| Word | Part of Speech |
|---|---|
| kore (it) | Noun |
| wa | Particle |
| warito (rather) | Adverb |
| suki (like) | Adjectival noun |
| da | Auxiliary verb |
| na | Particle |

TABLE 6
Morphological analysis result of speech example N3

| Word | Part of Speech |
|---|---|
| kore (it) | Noun |
| ga | Particle |
| ii (love) | Adjective |
| na | Particle |

TABLE 7
Morphological analysis result of speech example N4

| Word | Part of Speech |
|---|---|
| maa-maa | Adjectival noun |
| kana | Particle |

TABLE 8
Morphological analysis result of speech example N5

| Word | Part of Speech |
|---|---|
| kirai (dislike) | Adjectival noun |

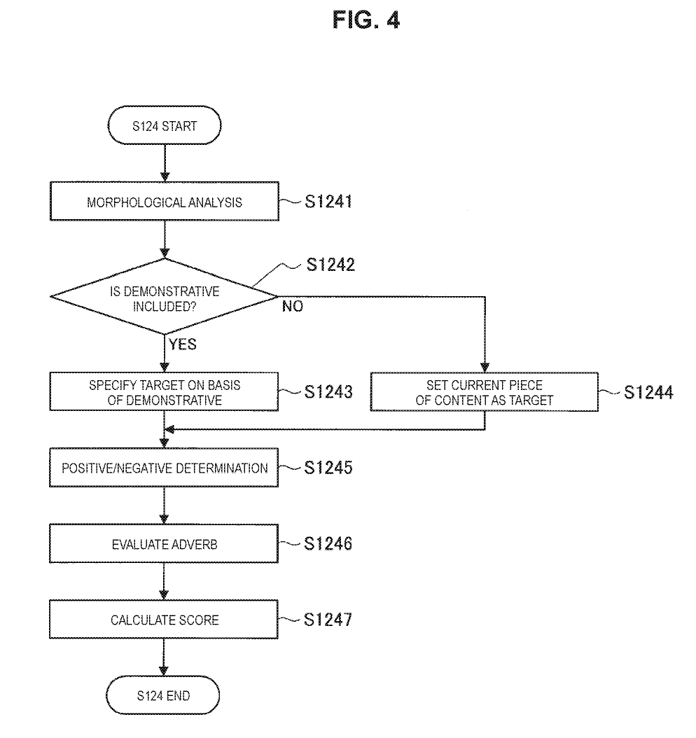

Note that, a detailed process of the scoring based on the morphological analysis result will be described later with reference to FIG. 4.

The content selection unit 105 illustrated in FIG. 2 selects a piece of content from the content list on the basis of a result of scoring performed by the scoring unit 104. For example, the content selection unit 105 may select a piece of content to which a score higher than a predetermined value is assigned, from the content list. In addition, in the case where the score of a piece of the content subjected to the scoring performed by the scoring unit 104 is higher than a predetermined value, the content selection unit 105 may select the piece of content. In addition, the content selection unit 105 may select a piece of content similar to the piece of content to which the score higher than the predetermined value is assigned, from the content list.

Note that, for example, pieces of content having the same information such as a genre, creator, or the like may be treated as the similar pieces of content. The information is associated with the pieces of content. In addition, for example, pieces of content having similar information such as a price or the like may be treated as the similar pieces of content. The information is associated with the pieces of content. Note that, for example, such information associated with pieces of content may be stored in the storage unit 17 (to be described later), or may be acquired from an outside via the communication unit 11 (to be described later).

The output control unit 106 controls output from the speaker 13, the projector unit 16, or the light emitting unit 18. For example, the output control unit 106 may sequentially output pieces of content (such as music) included in the content list generated by the content list management unit 102 (such as reproduction for trial listening). In addition, the output control unit 106 may cause output (such as full reproduction) of a piece of content selected by the content selection unit 105. In addition, the output control unit 106 may control output for a conversation between the information processing device 1 and the user.

In addition, the output control unit 106 may cause output of a result of scoring performed by the scoring unit 104. The output control unit 106 may output the result of scoring by using various methods. For example, it is possible for the output control unit 106 to control the projector unit 16 and cause the projector unit 16 to display a bar showing a score (score bar) as the result of the scoring, like the scoring result D10 illustrated in FIG. 1.

This configuration causes the user to understand that voice evaluation made by himself/herself is connected to the scoring, by displaying the scoring result. Accordingly, it is possible for the user to feel that the personalization technology works. In addition, since the user understands that the voice evaluation made by himself/herself is connected to scoring, the user is expected to speak voice evaluation more proactively.

The communication unit 11 exchanges data with an external device. For example, the communication unit 11 may connect with a predetermined server (not illustrated) via a communication network (not illustrated), and may receive content and information related to (associated with) the content.

The sound collection unit 12 has a function of collecting peripheral sounds and outputting the collected sound to the control unit 10 as a sound signal. In addition, the sound collection unit 12 may be implemented by one or a plurality of microphones, for example.

The speaker 13 has a function of converting a voice signal into a voice and outputting the voice under the control of the output control unit 106.

The camera 14 has a function of capturing an image of periphery by using an imaging lens installed in the information processing device 1, and outputting the captured image to the control unit 10. In addition, for example, the camera 14 may be a 360-degree camera, a wide angle camera, or the like.

The ranging sensor 15 has a function of measuring distances between the information processing device 1, a user, and people around the user. For example, the ranging sensor 15 may be implemented by an optical sensor (a sensor configured to measure a distance to a target object on the basis of information regarding phase difference between a light emitting timing and a light receiving timing).

The projector unit 16 is an example of a display device, and has a function of projecting and displaying an (enlarged) image on a wall or a screen.

The storage unit 17 stores programs and parameters for causing the respective structural elements of the information processing device 1 to function. For example, the storage unit 17 may store information related to a user such as identification information of the user, content, information associated with the content, information regarding past scoring results, and the like.

The light emitting unit 18 may be implemented by light emitting elements such as LEDs, and it is possible to control lighting manners and lighting positions of the light emitting unit 18 such that all lights are turned on, a part of the light is turned on, or the lights are blinking. For example, under the control of the control unit 10, a part of the light emitting unit 18 in a direction of a talker recognized by the speech recognition unit 103 is turned on. Accordingly, it is possible for the information processing device 1 to operate as if the information processing device 1 looks on the direction of the talker.

The details of the configuration of the information processing device 1 according to the embodiment have been described above. Note that, the configuration of the information processing device 1 illustrated in FIG. 2 is a mare example. The present embodiment is not limited thereto. For example, the information processing device 1 may further include an infrared (IR) camera, a depth camera, a stereo camera, a motion detector, or the like to acquire information regarding an ambient environment. In addition, the information processing device 1 may further include a touchscreen display, a physical button, or the like as a user interface. In addition, installation positions of the sound collection unit 12, the speaker 13, the camera 14, the light emitting unit 18, and the like in the information processing device 1 are not specifically limited. In addition, the functions of the control unit 10 according to the embodiment may be in another information processing device connected via the communication unit 11.

### <<3. Operation>>

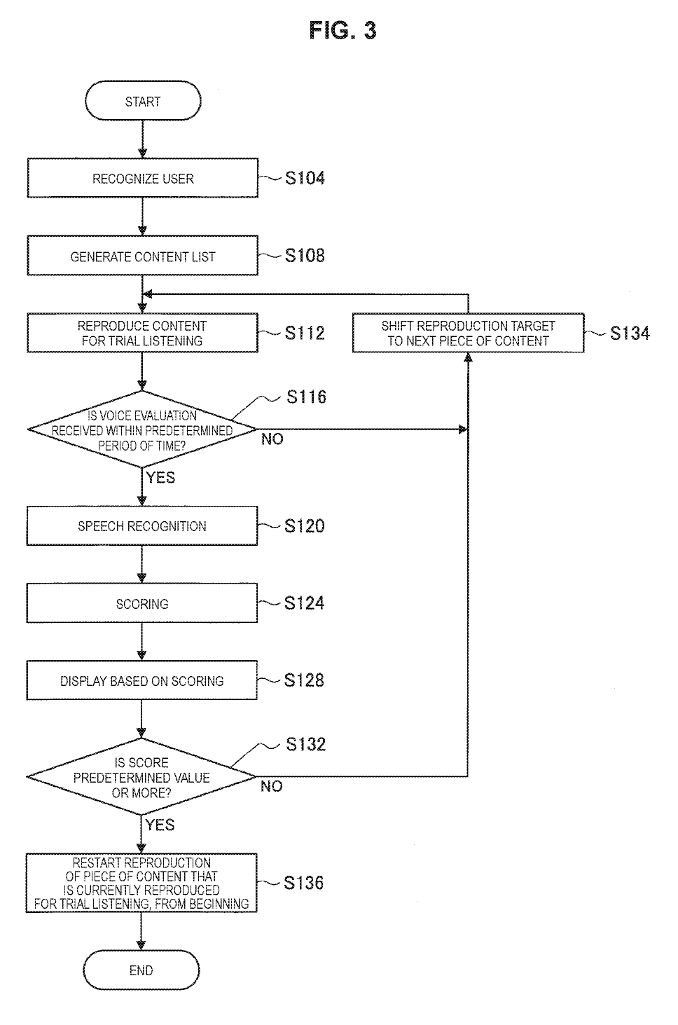

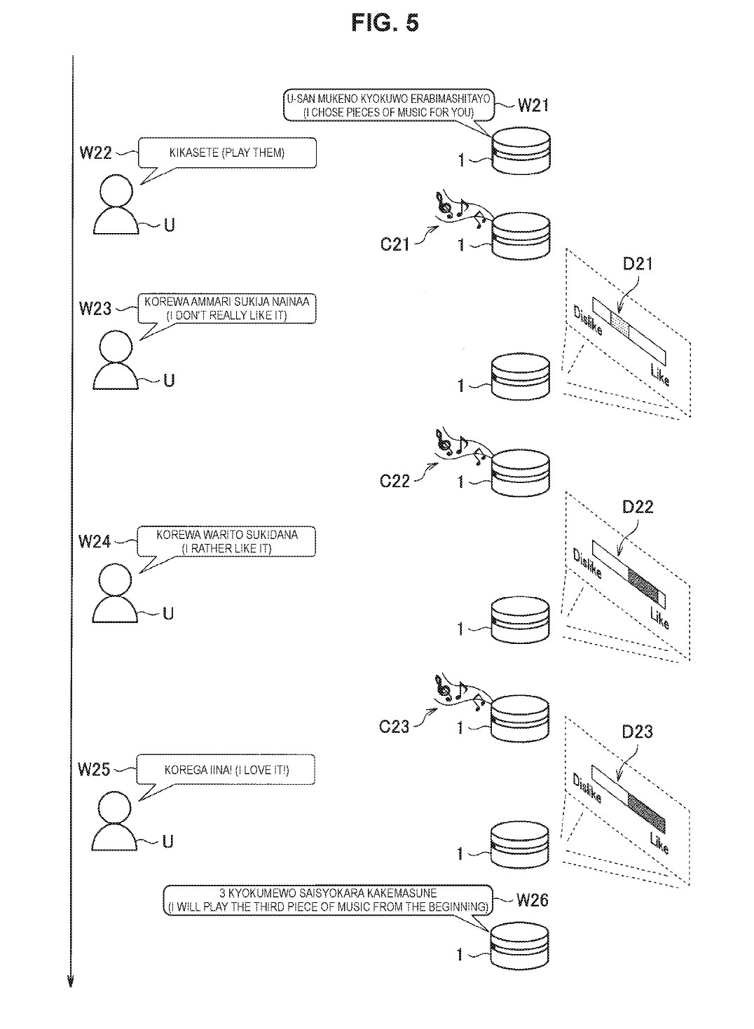

Next, with reference to FIG. 3 to FIG. 5, an operation example of the information processing device 1 according to the present embodiment will be described. First, with reference to FIG. 3 and FIG. 4, a process workflow according to the present embodiment will be described. Next, with reference to FIG. 5, a specific example of the conversational operation according to the present embodiment will be described.

### <3-1. Process Workflow>

Hereinafter, with reference to FIG. 3, an overall process workflow according to the present embodiment will be described. Next, with reference to FIG. 4, a process workflow of scoring based on semantic analysis performed by the scoring unit 104 with regard to a natural speech, will be described.

FIG. 3 is a flowchart illustrating an example of a process workflow of the information processing device 1 according to the present embodiment. First, as illustrated in FIG. 3, the user recognition unit 101 detects a user around the information processing device 1, and recognizes the detected user (S104). Next, the content list management unit 102 generates a content list including a plurality of pieces of content on the basis of a past scoring result related to the recognized user (S108).

Next, a piece of the content included in the content list is reproduced (partially output) for trial listening under the control of the output control unit 106 (S112). In the case where the speech recognition unit 103 determines that the user has spoken voice evaluation within a predetermined period of time (YES in S116), the speech recognition unit 103 performs speech recognition on the basis of the voice evaluation, and acquires speech text (S120).

Next, the scoring unit 104 performs scoring on the basis of the speech text acquired by the speech recognition unit 103 (S124). As described with reference to the table 1 to table 8, the scoring unit 104 may perform scoring on the basis of score wording indicating a score, or may perform scoring on the basis of predetermined wording associated with a score. In addition, as described later with reference to FIG. 4, the scoring unit 104 may perform scoring on the basis of morphological analysis of speech text.

Next, the output control unit 106 controls the projector unit 16, and causes the projector unit 16 to display a scoring result on the basis of the scoring, for example (S128). In addition, in the case where the score obtained through the scoring (the score specified) in Step S124 is a predetermined value or more (YES in S132), the process proceeds to Step S136. In Step S136, the content selection unit 105 selects the piece of content that is currently reproduced for trial listening, and the reproduction of the piece of content is restarted from the beginning under the control of the output control unit 106.

On the other hand, the process proceeds to Step S134 in the case where no voice evaluation is received within the predetermined period of time in Step S116 (NO in S116), or in the case where the score is less than the predetermined value in Step S132 (NO in Step S132). In Step S134, the reproduction target shifts to a next piece of the content. Subsequently, the process returns to Step S112, and the next piece of content is reproduced for trial listening.

Note that, a next content list generation process (S108) is performed on the basis of a result of the scoring obtained through Step S104 to Step S136 described above (the next content list generation process reflects the scoring result).

The overall process workflow according to the present embodiment has been described above. Next, with reference to FIG. 4, a process workflow of the scoring process (S124) illustrated in FIG. 3 in the case where the scoring unit 104 performs scoring on the basis of morphological analysis of speech text, will be described. FIG. 4 is a flowchart illustrating an example of the process workflow of scoring performed by the scoring unit 104. Note that, hereinafter, specific score calculation examples will be described with regard to the speech examples illustrated in the above-listed tables 3 to 8.

First, the scoring unit 104 performs morphological analysis on the speech text acquired by the speech recognition unit 103 (S1241). Next, the scoring unit 104 determines whether a demonstrative is included in the speech text on the basis of a result of the morphological analysis (S1242). In the case where the demonstrative is included (YES in S1242), a piece of content to be a scoring target is specified and set on the basis of the demonstrative (S1243). On the other hand, in the case where no demonstrative is included (NO in S1242), the piece of content that is currently reproduced for trial listening is set as the target (S1244).

For example, the speech example N1 to the speech example N3 in the speech examples shown in the table 3 to table 8 include a demonstrative “kore (it)”. Therefore, the piece of content that is currently reproduced for trial listening is set as the target. On the other hand, the speech examples N4 and N5 include no demonstrative. Therefore, the piece of content that is currently reproduced for trial listening is set as the target.

Next, the scoring unit 104 determines whether the voice evaluation is positive evaluation or negative evaluation. For example, the scoring unit 104 may determine whether the voice evaluation is positive evaluation or negative evaluation, on the basis of a word specified as an adjective or an adjectival noun through the morphological analysis of the speech text. Note that, the scoring unit 104 may determine that the voice evaluation is neither positive evaluation nor negative evaluation (neutral evaluation).

For example, the speech example N1 includes a combination of an adjectival noun “suki (like)” and an adjective “nai (don't). Therefore, voice evaluation of the speech example N1 may be determined as negative evaluation. In addition, the speech example N2 includes the adjectival noun “suki (like)”. Therefore, voice evaluation of the speech example N2 may be determined as positive evaluation. In addition, the speech example N3 includes an adjective “ii (love)”. Therefore, voice evaluation of the speech example N3 may be determined as positive evaluation. In addition, the speech example N4 includes an adjectival noun “maa-maa (so-so)”. Therefore, voice evaluation of the speech example N4 may be determined as neutral evaluation. In addition, the speech example N5 includes an adjectival noun “kirai (dislike)”. Therefore, voice evaluation of the speech example N5 may be determined as negative evaluation.

Next, the scoring unit 104 evaluates a word specified as an adverb through the morphological analysis of the speech text (S1246). For example, in Step S1246, the scoring unit 104 may evaluate the word specified as the adverb and specify a coefficient to be used in a score calculation process in Step S1247 (to be described later).

For example, the speech example N1 includes an adverb “amari (really)”. Therefore, a coefficient related to the speech example N1 may be specified as 0.6. In addition, the speech example N2 includes an adverb “warito (rather)”. Therefore, a coefficient related to the speech example N2 may be specified as 0.6. In addition, the speech examples N3 to N5 include no adverb. Therefore, coefficients related to the speech examples N3 to N5 may be determined to be 1.0.

Note that, the above-described processes in Step S1245 and Step S1246 may be performed on the basis of association between pre-registered words and positive/negative evaluation or coefficients, or on the basis of various natural language processing technologies.

Next, the scoring unit 104 calculates a score on the basis of a result of the determination made in Step S1245 and the coefficient obtained in Step S1246 (S1247). For example, the scoring unit 104 may calculate the score by using the following equation (1).

Score=reference score+determination score×coefficient (1)

In the equation 1, the reference score may be “50 points”, for example. In addition, the determination score may be a value based on the determination made in Step S1245, for example. The determination score may be “+50 points” if the evaluation is determined as positive evaluation in Step S1245, the determination score may be “−50 points” if the evaluation is determined as negative evaluation, and the determination score may be “0 point” if the evaluation is determined as neutral evaluation.

For example, scores of the speech examples N1 to N5 shown in the table 3 to table 8 are calculated by using the following equations (2) to (6), respectively.

Reference score (50 points)+determination score (−50 points)×coefficient (0.6)=20 points (2)

Reference score (50 points)+determination score (50 points)×coefficient (0.6)=80 points (3)

Reference score (50 points)+determination score (50 points)×coefficient (1.0)=100 points (4)

Reference score (50 points)+determination score (0 point)×coefficient (1.0)=50 points (5)

Reference score (50 points)+determination score (−50 points)×coefficient (1.0)=0 points (6)

### <3-2. Specific Example>

The process workflows according to the present embodiment have been described above. Next, with reference to FIG. 5, a specific example of conversational operation with a user according to the present embodiment will be described. FIG. 5 is an explanatory diagram illustrating a specific example of a conversational operation with a user according to the present embodiment.

First, the information processing device 1 outputs a speech W21 for telling the user U that a content list including pieces of content (music) aimed at the user U is generated. Next, when the user U speaks a response W22 indicating that the user U wants to reproduce the content list for trial listening, the information processing device 1 reproduces a piece C21 of the content in the content list. When the user U speaks voice evaluation W23 of the piece C21 of the content, the information processing device 1 displays a scoring result D21 based on the voice evaluation W23. Note that, the scoring result D21 indicates that the score of the piece C21 of the content is 20 points.

Here, the score of the piece C21 of the content is smaller than the predetermined value in Step S132 in FIG. 3. Therefore, the information processing device 1 reproduces a next piece C22 of the content in the content list for trial listening. When the user U speaks voice evaluation W24 of the piece C22 of the content, the information processing device 1 displays a scoring result D22 based on the voice evaluation W24. Note that, the scoring result D22 indicates that the score of the piece C22 of the content is 80 points.

Here, the score of the piece C22 of the content is smaller than the predetermined value in Step S132 in FIG. 3. Therefore, the information processing device 1 reproduces a next piece C23 of the content in the content list for trial listening. When the user U speaks voice evaluation W25 of the piece C23 of the content, the information processing device 1 displays a scoring result D23 based on the voice evaluation W25. Note that, the scoring result D23 indicates that the score of the piece C23 of the content is 100 points.

Here, the score of the piece C23 of the content is more than or equal to the predetermined value in Step S132 in FIG. 3. Therefore, the information processing device 1 selects the piece C23 of the content, and outputs a speech W26 indicating that the whole piece C23 of the content will be reproduced (output) from the beginning.

The specific example of conversational operation with the user according to the present embodiment has been described above. However, the conversational operation with a user according to the present embodiment is not limited thereto. Needless to say, various types of conversational operation are performed in accordance with users, pieces of content, and the like.

### <<4. Modifications>>

The embodiment of the present disclosure has been described above. Next, some modifications of the embodiment according to the present disclosure will be described. Note that, the modifications to be described below may be separately applied to the embodiment according to the present disclosure, or may be applied to the modification according to the present disclosure in combination. In addition, the modifications may be applied instead of the configuration described in the embodiment according to the present disclosure, or may be applied in addition to the configuration described in the embodiment according to the present disclosure.

### <4-1. First Modification>

The example of selecting a piece of content that is currently reproduced for trial listening in the case where a score is a predetermined value or more in Step S132 in FIG. 3 has been described above. However, the present technology is not limited thereto.

For example, the content selection unit 105 may select a piece of content after scoring is performed on all pieces of the content included in the content list. In this case, the content selection unit 105 may select a piece of the content to which a score of a predetermined value or more is assigned, or may select a predetermined number of pieces of the content in descending order of score.

This configuration enables more precise checking of pieces of content to which high scores are assigned, comparison between pieces of the content, or the like after a user simply checks a number of pieces of the content, for example.

### <4-2. Second Modification>

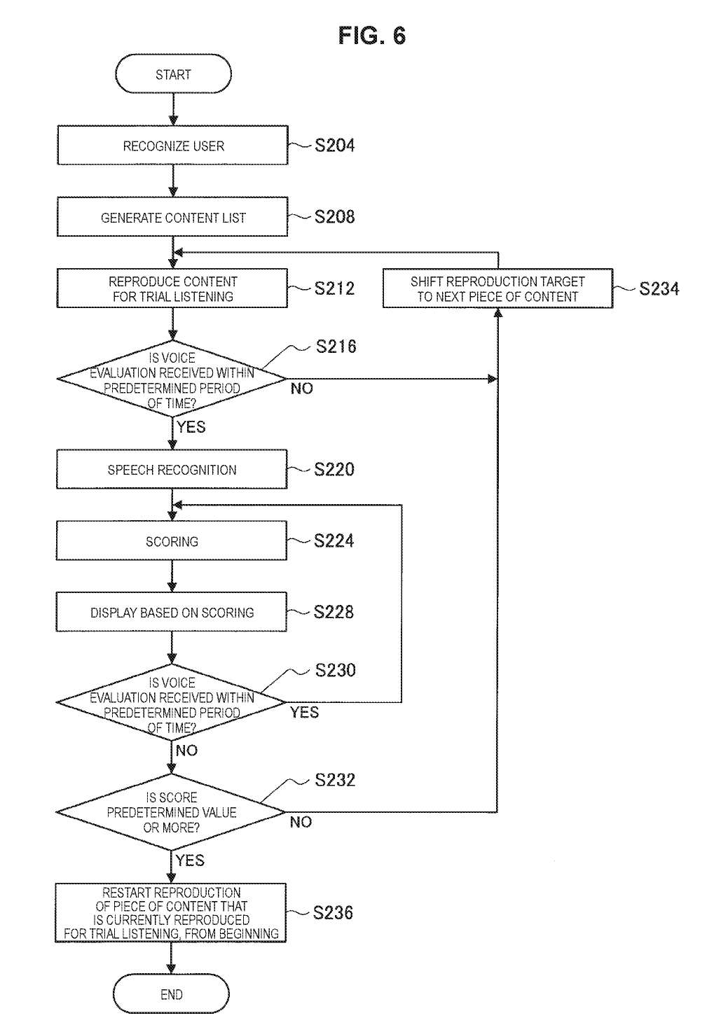

In addition, the example in which scoring is performed just one time for each piece of content has been described above. However, the present technology is not limited thereto. For example, in the case where the user again speaks voice evaluation of a piece of content that has been subjected to the scoring, the scoring unit 104 may perform scoring of the piece of content again. Hereinafter, with reference to FIG. 6 to FIG. 8, a modification in which the scoring unit 104 performs scoring again on a same piece of content, will be described.

FIG. 6 is a flowchart illustrating an example of a process workflow of the information processing device 1 in the case where the scoring unit 104 performs scoring again on a same piece of content. Processes in Steps S204 to S228 illustrated in FIG. 6 are similar to the processes in Steps S104 to S128 described with reference to FIG. 3. Accordingly, repeated description will be omitted.

Next, in the case where the speech recognition unit 103 determines that the user has spoken voice evaluation within a predetermined period of time (NO in S230), the process returns to Step S224 and the scoring unit 104 performs scoring again on the basis of the voice evaluation.

On the other hand, in the case where the speech recognition unit 103 dos not determine that the user has spoken voice evaluation within the predetermined period of time, the process returns to Step S232. Note that, processes in Steps S232 to S236 are similar to the processes in Steps S132 to S136 described with reference to FIG. 3. Accordingly, repeated description will be omitted.

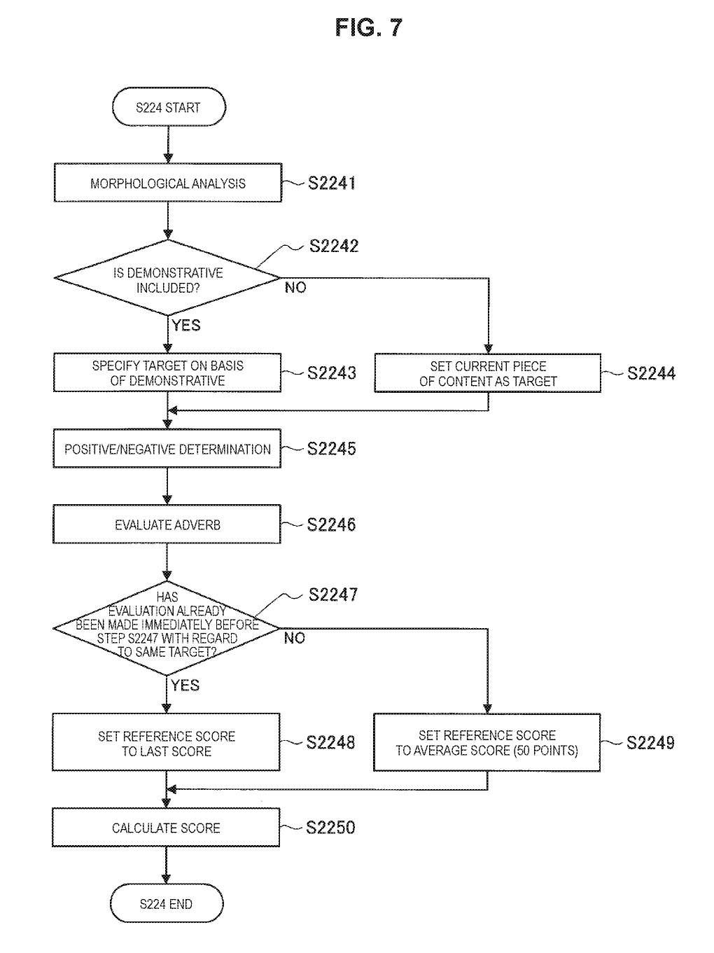

FIG. 7 is a flowchart illustrating an example of a workflow of a scoring process performed in the case where the scoring unit 104 performs scoring again on a same piece of content. Processes in Steps S2241 to S2246 illustrated in FIG. 7 are similar to the processes in Steps S1241 to S1246 described with reference to FIG. 7. Accordingly, repeated description will be omitted.

In the case where voice evaluation has already been made immediately before Step S2247 with regard to the target piece of content that is set in Steps S2243 and S2244 (YES in S2247), the reference score is set to a score obtained through the scoring process based on the last voice evaluation (S2248). On the other hand, in the case where voice evaluation has not been made immediately before Step S2247 with regard to the target piece of content that is set in Steps S2243 and S2244 (NO in S2247), the reference score is set to 50 points that is an average score.

Next, the scoring unit 104 calculates a score (S2250). For example, the scoring unit 104 may calculate the score by using the above-described equation (1) and the reference score set in Steps S2248 and S2249.

The table 9 listed below is a table showing examples of scoring performed in the case where the scoring is performed again on the same target.

TABLE 9
Examples of scoring of same target

| Speech Example | Score Example | |
|---|---|---|
| N4: maa-maa kana (so-so) | 50 | points |
| ↓ | ↓ | |
| N6: iya, warito sukidayo (No, I rather like it) | 80 | points |
| N5: kirai (I dislike it) | 0 | point |
| ↓ | ↓ | |
| N6: iya, warito sukidayo (No, I rather like it) | 30 | points |

In addition, the table 10 listed below is a table showing a morphological analysis result of the speech examples N6 and N7 in the table 9.

TABLE 10
Morphological analysis result of speech examples N6 and N7

| Word | Part of Speech |
|---|---|
| iya (No) | Interjection |
| warito (rather) | Adverb |
| suki (like) | Adjectival noun |
| da | Auxiliary verb |
| yo | Particle |

The speech examples N6 and N7 in the tables 9 and 10 include the adjectival noun “suki (like)”. Therefore, in Step S2245, voice evaluation of the speech examples N6 and N7 may be determined as positive evaluation. In addition, the speech examples N6 and N7 include the adverb “warito (rather)”. Therefore, in Step S2246, coefficients related to the speech examples N6 and 7 may be specified as 0.6.

In addition, in Step S2248, the reference score related to the speech example N6 may be set to 50 points that is the score related to the last speech example N4. In addition, in Step S2248, the reference score related to the speech example N7 may be set to 0 point that is the score related to the last speech example N5.

Therefore, in Step S2250, scores of the speech examples N6 and N7 are calculated by using the following equations (7) and (8), respectively.

Reference score (50 points)+determination score (+50 points)×coefficient (0.6)=80 points (7)

Reference score (0 points)+determination score (50 points)×coefficient (0.6)=30 points (8)

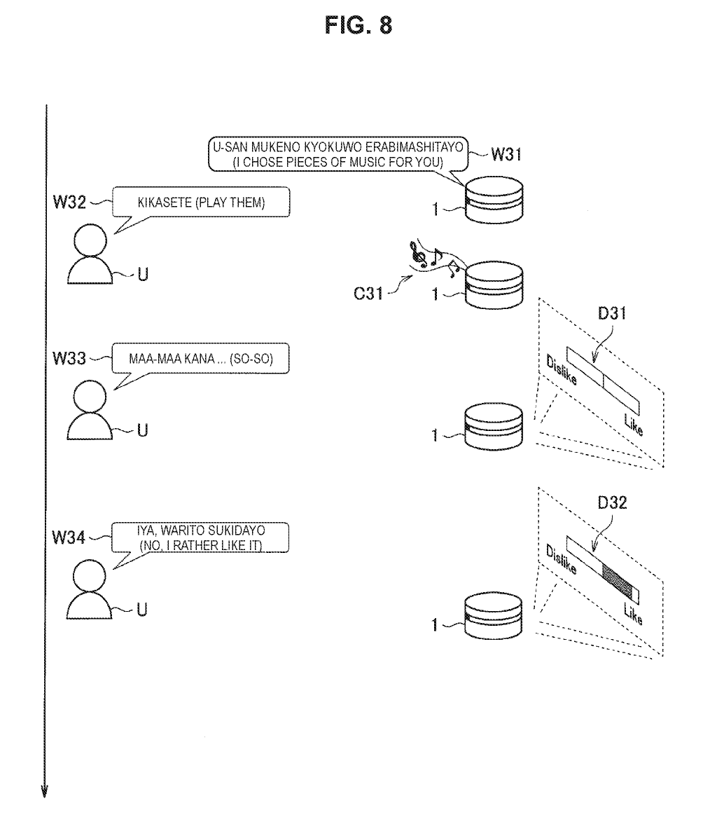

The process workflows according to the modifications have been described above. Next, with reference to FIG. 8, a specific example of conversational operation with a user according to the modification will be described. FIG. 8 is an explanatory diagram illustrating a specific example of a conversational operation with a user according to the modification.

First, the information processing device 1 outputs a speech W31 for telling the user U that a content list including pieces of content (music) aimed at the user U is generated. Next, when the user U speaks a response W32 indicating that the user U wants to reproduce the content list for trial listening, the information processing device 1 reproduces a piece C31 of the content in the content list for trial listening. When the user U speaks voice evaluation W33 of the piece C31 of the content, the information processing device 1 displays a scoring result D31 based on the voice evaluation W33. Note that, the scoring result D31 indicates that the score of the piece C31 of the content is 50 points.

Here, when the user U who has seen the scoring result D31 speaks another voice evaluation W34 within the predetermined period of time illustrated in Step S230 in FIG. 6, the information processing device 1 performs scoring again and displays a scoring result D32 based on the voice evaluation W34.

As described above, according to the present modification, it is possible for the user to check the scoring result and correct the score.

Note that, in the case where a speech for correcting the score is spoken as described above, the coefficient specified in Step S2240 in FIG. 7 and the score calculation method in Step S2250 may be changed for each user, in the subsequent process. For example, different coefficients may be specified for “warito (rather)” in voice evaluation made by a certain user and “warito (rather)” in voice evaluation made by another user.

### <4-3. Third Modification>

In addition, the example in which the scoring unit 104 calculates a score by using the equation (1) has been described above. However, the present technology is not limited thereto.

For example, the scoring unit 104 may perform scoring on the basis of a response time from output of a piece of content (such as reproduced for trial listening) to voice evaluation made by a user. For example, the scoring unit 104 may determine whether the response time is long or short by comparing the response time with a predetermined period of time. The table 11 listed below is a table showing examples of scoring based on response time.

TABLE 11
Examples of scoring based on response time

| | Speech Content | | |
|---|---|---|---|
| Response Time | (Positive/Negative) | Score Example | |
| Short | Positive | 100 | points |
| Long | Positive | 70 | points |
| Long | Negative | 30 | points |
| Short | Negative | 0 | point |

For example, the scoring unit 104 determines whether a hesitation word is included in voice evaluation, and performs the scoring on the basis of a result of the determination. The table 12 listed below is a table showing examples of scoring based on determination of a hesitation word.

TABLE 12
Examples of scoring based on hesitation word

| Presence or Absence of | Speech Content | | |
|---|---|---|---|
| Hesitation Word | (Positive/Negative) | Score Example | |
| Absent | Positive | 100 | points |
| Present | Positive | 70 | points |
| Present | Negative | 50 | points |
| Absent | Negative | 30 | points |

### <4-4. Fourth Modification>

In addition, the example in which the scoring unit 104 performs scoring of a piece of content on the basis of a voice evaluation, has been described above. However, the present technology is not limited thereto.

For example, the scoring unit 104 may perform scoring of a certain piece of content and another piece of content that is similar to the certain piece of content, on the basis of a voice evaluation of the certain piece of content. For example, the same score may be assigned to the certain piece of content and the another piece of content that is similar to the certain piece of content, on the basis of the voice evaluation of the certain piece of content.

This configuration enables personalization with higher accuracy even in the case where the user has made only a small number of voice evaluations.

### <4-5. Fifth Modification>

In addition, the operation example in which a user voluntarily makes voice evaluation has been described above. However, the present technology is not limited thereto. For example, the output control unit 106 may cause output of information that prompts the user to make the voice evaluation.

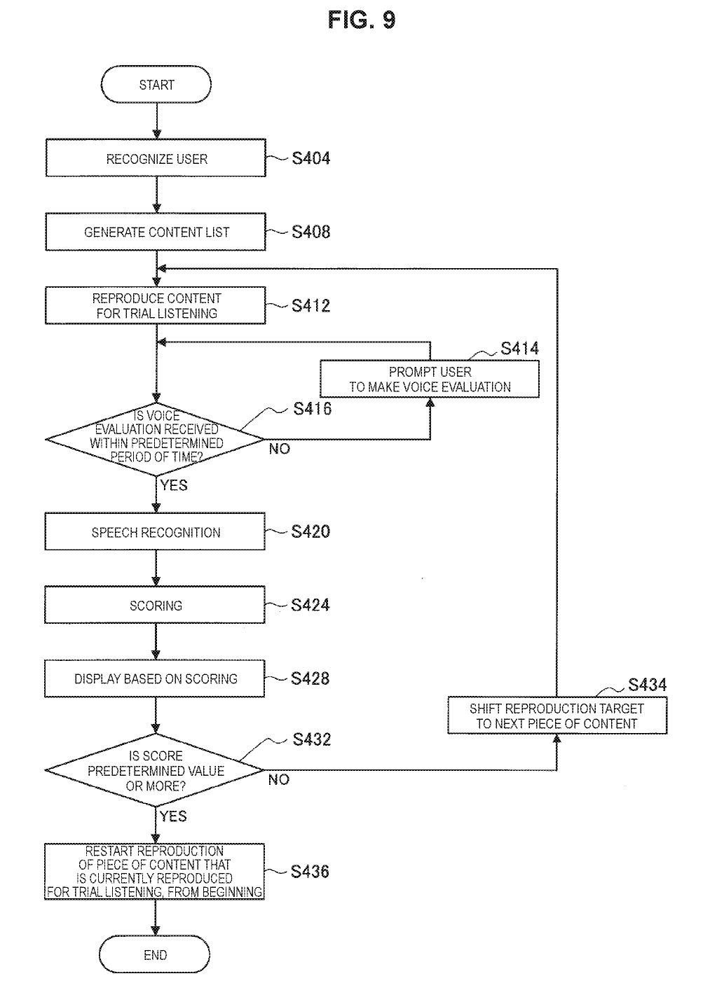

FIG. 9 is a flowchart illustrating an example of an overall process workflow in the case where the output control unit 106 prompts a user to make voice evaluation. Processes in Steps S404 to S412 illustrated in FIG. 9 are similar to the processes in Steps S104 to S112 described with reference to FIG. 3. Accordingly, repeated description will be omitted.

In the case where voice evaluation made by the user is not recognized within a predetermined period of time in Step S416 (NO in S416), the output control unit 106 outputs the information that prompts the user to make voice evaluation. For example, the output control unit 106 may control the speaker 13 and cause the speaker 13 to output voice that prompts the user to make voice evaluation.

Subsequent processes in Steps S420 to S436 are similar to the processes in Steps S120 to S136 described with reference to FIG. 3. Accordingly, repeated description will be omitted.

This configuration enables prompting the user to make voice evaluation even in the case where the user does not recognize that scoring is performed on the basis of the voice evaluation. Therefore, it is possible to provide pieces of content more suitable for the user, for example.

### <4-6. Sixth Modification>

In addition, the example in which a result of scoring is displayed as a score bar like the scoring result D10 illustrated in FIG. 1 has been described above, for example. However, the present technology is not limited thereto. It is possible for the output control unit 106 to cause output of the result of scoring by using various methods.

For example, the output control unit 106 may control the projector unit 16 and cause the projector unit 16 to display the score in a text form. In addition, the output control unit 106 may control the speaker 13 and cause the speaker 13 to output the score by voice.

In addition, the output control unit 106 may output (display, for example) a ranking result (rank order) as the result of scoring. The ranking result is a ranking of a plurality of pieces of content included in a content list based on scoring of the plurality of pieces of content. Note that, in this case, the scoring unit 104 may perform scoring on the basis of voice evaluation indicating comparison between the pieces of content or indicating the ranking thereof.

### <4-7. Seventh Modification>

In addition, the example in which there is only one user has been described above. However, the present technology is not limited thereto. Needless to say, the present technology can also be applied to a case where there are a plurality of users.

For example, the scoring unit 104 may perform scoring on the basis of voice evaluation made by a plurality of users, and the output control unit 106 may output a result of the scoring for each of the users (for example, a ranking result of plurality of pieces of content). This configuration makes it easier for the user to feel that the personalization works according to the present technology.

### <4-8. Eighth Modification>

In addition, the example in which the content list management unit 102 manages (generates or updates) a content list on the basis of scoring results, has been described above. However, the present technology is not limited thereto.

In addition, the content list management unit 102 may manage the content list further on the basis of histories of operations, selections, viewing, and the like performed by the user. This configuration enables generation of the content list even in the case where the user has not made voice evaluation in the past.

For example, the content list management unit 102 may manage the content list further on the basis of an endogenous state (such as physical condition or busyness) or an exogenous state (such as season, weather, or going to a concert of a certain artist) of the user. Note that, in a similar way, the scoring unit 104 may perform scoring further on the basis of information regarding the endogenous state of the user, or external factors.

This configuration enables provision of pieces of content not only on the basis of voice evaluation made by the user but also on the basis of the endogenous state or the exogenous state of the user. Therefore, it is possible to provide pieces of content suitable for the user even in the case where preference of the user is changed, for example.

### <<5. Hardware Configuration Example>>

The embodiment of the present disclosure has been described above. The above-described information processes such as the user recognition process, content list management process, speech recognition process, scoring process, content selection process, output control process, and the like are achieved by operating cooperatively software and the information processing device 1. Next, a hardware configuration example of an information processing device 1000 will be described as a hardware configuration example of the information processing device 1 that is an information processing device according to the present embodiment.

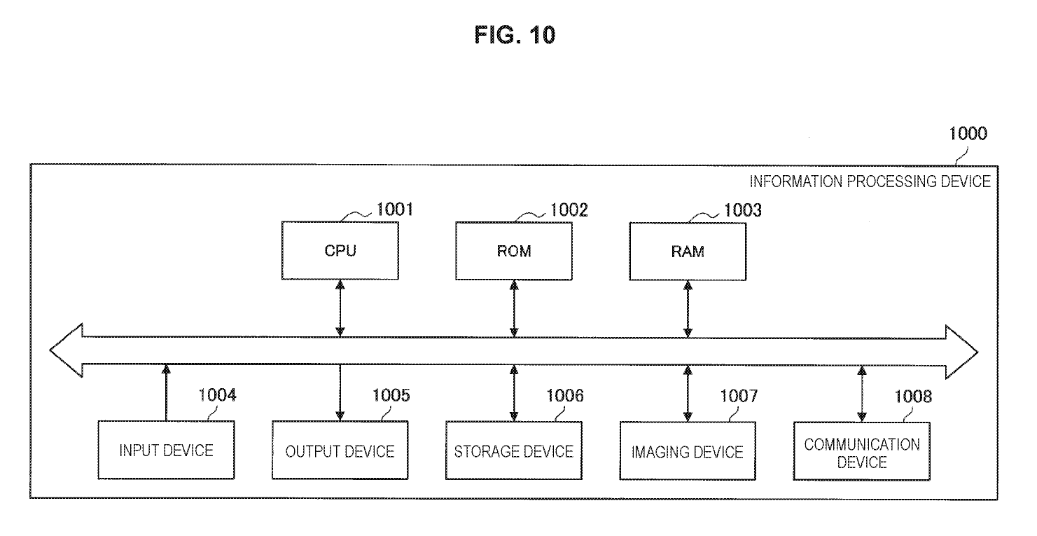

FIG. 10 is an explanatory diagram illustrating an example of a hardware configuration of the information processing device 1000. As illustrated in FIG. 10, the information processing device 1000 includes a central processing unit (CPU) 1001, read only memory (ROM) 1002, random access memory (RAM) 1003, an input device 1004, an output device 1005, a storage device 1006, an imaging device 1007, and a communication device 1008.

The CPU 1001 functions as an arithmetic processing device and a control device to control all of the operating processes in the information processing device 1000 in accordance with various kinds of programs. In addition, the CPU 1001 may be a microprocessor. The ROM 1002 stores programs, operation parameters, and the like used by the CPU 1001. The RAM 1003 transiently stores programs used when the CPU 1001 is executed, various parameters that change as appropriate when executing such programs, and the like. They are connected to each other via the host bus including a CPU bus or the like. Mainly, the function of the control unit 10 is achieved by cooperatively operating software, the CPU 1001, the ROM 1002, and the RAM 1003.

The input device 1004 includes: an input mechanism used by the user for imputing information, such as a mouse, a keyboard, a touch screen, a button, a microphone, a switch, or a lever; an input control circuit configured to generate an input signal on the basis of user input and output the signal to the CPU 1001; and the like. By operating the input device 1004, the user of the information processing device 1000 can input various kinds of data into the information processing apparatus 1000 and instruct the information processing apparatus 100 to perform a processing operation.

The output device 1005 includes a display device such as a liquid crystal display (LCD) device, an OLED device, a see-through display, or a lamp, for example. Further, the output device 1005 includes audio output device such as a speaker or headphones. For example, the display device displays captured images, generated images, and the like. On the other hand, the audio output device converts audio data or the like into audio and outputs the audio. The output device 1005 corresponds to the speaker 13, the projector unit 16, and the light emitting unit 18 described with reference to FIG. 2, for example.

The storage device 1006 is a device for storing data. The storage device 1006 may include a storage medium, a recording device which records data in a storage medium, a reader device which reads data from a storage medium, a deletion device which deletes data recorded in a storage medium, and the like. The storage device 1006 stores therein the programs executed by the CPU 1001 and various data. The storage device 1006 corresponds to the storage unit 17 described with reference to FIG. 2.

The imaging device 1007 includes an imaging optical system such as an imaging lens or a zoom lens configured to collect light, and a signal conversion element such as a charge coupled device (CCD) or a complementary metal oxide semiconductor (CMOS). The image optical system collects light emitted from a subject and forms a subject image on a signal conversion unit, and the signal conversion element converts the formed subject image into an electrical image signal. The imaging device 1007 corresponds to the camera 14 described with reference to FIG. 2.

The communication device 1008 is a communication interface including, for example, a communication device or the like for connection to a communication network. Further, the communication device 1008 may include a communication device that supports a wireless local area network (LAN), a communication device that supports long term evolution (LTE), a wired communication device that performs wired communication, or a communication device that supports Bluetooth (registered trademark). The communication device 1008 corresponds to the communication unit 11 described with reference to FIG. 2, for example.

### <<6. Conclusion>>

As described above, according to the embodiment of the present disclosure, scoring is performed on the basis of voice evaluation made by a user with regard to pieces of content, and a piece of the content is selected. This enables reduction in burden on the user and provision of the piece of content suitable for the user. In addition, output of a scoring result based on voice evaluation made by the user prompts the user to make voice evaluation, and it is possible for the user to feel that the personalization is performed.

In addition, for example, it is also possible to output a speech that cites a content of past voice evaluation like “you have said before that you like it, so I chose pieces of music of an artist similar to it” when providing the pieces of content. Accordingly, more improvement in satisfaction of the user is expected.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, in the above-described embodiment, the music is used as an example of the content. However, the present technology is not limited thereto. For example, the content may be various kinds of information to be provided to users such as video, images, news, TV programs, movies, restaurants, menus, travel destination information, or web pages.

In addition, it may not be necessary to chronologically execute respective steps according to the above described embodiment, in the order described in the flow charts. For example, the respective steps in the processes according to the above described embodiment may be processed in the order different from the order described in the flow charts, and may also be processed in parallel.

In addition, according to the above described embodiment, it is also possible to provide a computer program for causing hardware such as the CPU 1001, ROM 1002, and RAM 1003, to execute functions equivalent to the structural elements of the above-described information processing device 1. Moreover, it may be possible to provide a recording medium having the computer program stored therein.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

a scoring unit configured to perform scoring on a basis of ambiguous voice evaluation made by a user with regard to a piece of content included in a content list including a plurality of pieces of the content; and

a content selection unit configured to select a piece of the content from the content list, on a basis of a result of the scoring.

(2)

The information processing device according to (1), further including

a content list management unit configured to manage the content list on a basis of the result of the scoring performed by the scoring unit.

(3)

The information processing device according to (2),

in which the content list management unit generates the content list on a basis of the result of the scoring.

(4)

The information processing device according to (2) or (3),

in which, each time the scoring unit performs the scoring, the content list management unit updates the content list on a basis of a result of the scoring.

(5)

The information processing device according to any one of (1) to (4),

in which the scoring unit detects predetermined wording associated with a score in speech text based on the voice evaluation, and performs the scoring on a basis of the predetermined wording.

(6)

The information processing device according to any one of (1) to (5),

in which the scoring unit performs scoring on a basis of a result of morphological analysis of speech text based on the voice evaluation.

(7)

The information processing device according to any one of (1) to (6),

in which the scoring unit determines whether the voice evaluation is positive evaluation or negative evaluation, and performs the scoring on a basis of a result of the determination.

(8)

The information processing device according to any one of (1) to (7),

in which the scoring unit performs the scoring on a basis of a response time from output of the piece of content to the voice evaluation.

(9)

The information processing device according to any one of (1) to (8),

in which the scoring unit determines whether a hesitation word is included in the voice evaluation, and performs the scoring on a basis of a result of the determination.

(10)

The information processing device according to any one of (1) to (9), further including

an output control unit configured to cause a result of the scoring to be output.

(11)

The information processing device according to (10),

in which the scoring unit performs scoring again on a basis of the voice evaluation made by the user with regard to the piece of content that has been subjected to the scoring.

(12)

The information processing device according to (10) or (11), in which

the scoring unit performs scoring on a basis of the voice evaluation made by a plurality of users, and

the output control unit causes a result of the scoring to be output for each of the users.

(13)

The information processing device according to any one of (10) to (12),

in which the output control unit causes information to be output, the information prompting the user to make the voice evaluation.

(14)

An information processing method including:

performing scoring by a processor on a basis of ambiguous voice evaluation made by a user with regard to a piece of content included in a content list including a plurality of pieces of the content; and

selecting a piece of the content from the content list, on a basis of a result of the scoring.

(15)

A program that causes a computer to achieve:

a function of performing scoring on a basis of ambiguous voice evaluation made by a user with regard to a piece of content included in a content list including a plurality of pieces of the content; and

a function of selecting a piece of the content from the content list, on a basis of a result of the scoring.

### REFERENCE SIGNS LIST

1 information processing device
10 control unit
11 communication unit
12 sound collection unit
13 speaker
14 camera
15 ranging sensor
16 projector unit
17 storage unit
18 light emitting unit
101 user recognition unit
102 content list management unit
103 speech recognition unit
104 scoring unit
105 content selection unit
106 output control unit

1. An information processing device comprising:
a scoring unit configured to perform scoring on a basis of ambiguous voice evaluation made by a user with regard to a piece of content included in a content list including a plurality of pieces of the content; and
a content selection unit configured to select a piece of the content from the content list, on a basis of a result of the scoring,
wherein the scoring unit performs scoring of a piece of content that is similar to the piece of content, on a basis of the voice evaluation corresponding to the piece of content.

2. The information processing device according to claim 1, further comprising
a content list management unit configured to manage the content list on a basis of the result of the scoring performed by the scoring unit.

3. The information processing device according to claim 2,
wherein the content list management unit generates the content list on a basis of the result of the scoring.

4. The information processing device according to claim 2,
wherein, each time the scoring unit performs the scoring, the content list management unit updates the content list on a basis of a result of the scoring.

5. The information processing device according to claim 1,
wherein the scoring unit detects predetermined wording associated with a score in speech text based on the voice evaluation, and performs the scoring on a basis of the predetermined wording.

6. The information processing device according to claim 1,
wherein the scoring unit performs scoring on a basis of a result of morphological analysis of speech text based on the voice evaluation.

7. The information processing device according to claim 1,
wherein the scoring unit determines whether the voice evaluation is positive evaluation or negative evaluation, and performs the scoring on a basis of a result of the determination.

8. The information processing device according to claim 1,
wherein the scoring unit performs the scoring on a basis of a response time from output of the piece of content to the voice evaluation.

9. The information processing device according to claim 1,
wherein the scoring unit determines whether a hesitation word is included in the voice evaluation, and performs the scoring on a basis of a result of the determination.

10. The information processing device according to claim 1, further comprising
an output control unit configured to cause a result of the scoring to be output.

11. The information processing device according to claim 10,
wherein the scoring unit performs scoring again on a basis of the voice evaluation made by the user with regard to the piece of content that has been subjected to the scoring.

12. The information processing device according to claim 10, wherein
the scoring unit performs scoring on a basis of the voice evaluation made by a plurality of users, and
the output control unit causes a result of the scoring to be output for each of the users.

13. The information processing device according to claim 10,
wherein the output control unit causes information to be output, the information prompting the user to make the voice evaluation.

14. An information processing method comprising:
performing scoring by a processor on a basis of ambiguous voice evaluation made by a user with regard to a piece of content included in a content list including a plurality of pieces of the content; and
selecting a piece of the content from the content list, on a basis of a result of the scoring,
wherein the processor performs scoring of a piece of content that is similar to the piece of content, on a basis of the voice evaluation corresponding to the piece of content.

15. A program that causes a computer to achieve:
a function of performing scoring on a basis of ambiguous voice evaluation made by a user with regard to a piece of content included in a content list including a plurality of pieces of the content; and
a function of selecting a piece of the content from the content list, on a basis of a result of the scoring,
wherein the function of performing scoring performs scoring of a piece of content that is similar to the piece of content, on a basis of the voice evaluation corresponding to the piece of content.
